(19) United States
(12) Patent Application Publication
(10) Pub. No.: US 2026/0171498 A1
(43) Pub. Date: Jun. 18, 2026

(54) ELECTROLYTE FOR LITHIUM METAL BATTERY AND LITHIUM METAL BATTERY INCLUDING THE SAME

(71) Applicants: HYUNDAI MOTOR COMPANY, SEOUL (KR); KIA CORPORATION, SEOUL (KR)

(72) Inventors: Jiho Lim, Hwaseong-si (KR); Ji Yong Lee, Hwaseong-si (KR); Won Keun Kim, Hwaseong-si (KR); Eunji Kwon, Hwaseong-si (KR); Samuel Seo, Hwaseong-si (KR); Kyuju Kwak, Hwaseong-si (KR); Seungjong Lee, Hwaseong-si (KR); Dong Hyun Lee, Hwaseong-si (KR); Sangsu Lee, Hwaseong-si (KR); Kyoung Han Ryu, Hwaseong-si (KR); Yeonjong Oh, Hwaseong-si (KR)

(73) Assignees: HYUNDAI MOTOR COMPANY, SEOUL (KR); KIA CORPORATION, SEOUL (KR)

(21) Appl. No.: 19/340,739

(22) Filed: Sep. 25, 2025

(30) Foreign Application Priority Data
Dec. 13, 2024 (KR) 10-2024-0185582

(51) Int. Cl. H01M 10/0567; H01M 4/38; H01M 4/525; H01M 10/052; H01M 10/0568; H01M 10/0569

(52) U.S. Cl. CPC H01M 10/0567; H01M 4/382; H01M 4/525; H01M 10/052; H01M 10/0568; H01M 10/0569; H01M 2300/0034

(57) ABSTRACT

An electrolyte for a lithium metal battery, which includes a lithium salt, a non-aqueous organic solvent, and a metal cation additive. The metal cation additive may include calcium and trifluoromethanesulfoneimide.

### CROSS-REFERENCE TO RELATED APPLICATION

This application claims priority to and the benefit of Korean Patent Application No. 10-2024-0185582 filed with the Korean Intellectual Property Office on Dec. 13, 2024, the entire contents of which are incorporated herein by reference.

### FIELD

The disclosure relates to an electrolyte for a lithium metal battery and a lithium metal battery including the same.

### BACKGROUND

As the electric vehicle market grows, there is an increasing need for high-capacity batteries that improve on or surpass lithium ion batteries and accordingly, an increasing demand for negative and positive electrode materials with high energy density and that provide long-term stability of the lithium metal batteries.

Lithium metal, which has high capacity per weight of 3,860 mAh/g and a low standard electrode potential (−3.04 V vs normal hydrogen electrode), has been used as a negative electrode material for rechargeable lithium batteries. However, lithium metal is highly reactive, which can create an extremely reducing atmosphere during the charging process, and which may cause an irreversible decomposition reaction between the lithium metal and an electrolyte. The decomposition reaction may deplete the electrolyte, and the decomposition products may form a nonuniform film on the lithium metal surface. In addition, lithium can form dendrites, as charging and discharging are repeated. The dendritic lithium causes electrical short circuits inside the batteries which lead to battery safety issues such as fires and the like.

Therefore, in order to utilize lithium metal in a way that provides high stability and high capacity, an electrolyte is needed that can alleviate reactivity of lithium metal, prevent dendritic lithium growth, and/or enable uniform lithium electrodeposition (plating).

### SUMMARY

An embodiment of the disclosure provides an electrolyte for a lithium metal battery capable of inducing uniform electrodeposition and desorption of lithium ions by forming a thin film on the surface of a current collector and/or a lithium metal.

In an additional embodiment the disclosure provides a lithium metal battery, e.g., comprising the electrolyte and capable of implementing excellent durability performance.

An electrolyte for a lithium metal battery according to an embodiment includes a lithium salt; a non-aqueous organic solvent; and a metal cation additive wherein the metal cation additive may include calcium (as a cation) and trifluoromethanesulfonimide (as an anion).

In embodiments, the metal cation additive may include calcium(II) bis(trifluoromethanesulfonimide).

In embodiments, the metal cation additive may be included in an amount of greater than 0.5 wt % and less than 5 wt % based on total weight of the electrolyte.

In embodiments, the non-aqueous organic solvent may include FSA.

In embodiments, the lithium salt may include at least one of LiFSI and/or LiTFSI.

In embodiments, the lithium salt concentration may be 2.5 M to 4.5 M.

In embodiments, the lithium salt and non-aqueous organic solvent may be included in a molar ratio of 1:3 (salt:solvent).

According to another embodiment, a lithium metal battery may include a positive electrode; a lithium metal layer as a negative electrode oriented toward (e.g., facing) the positive electrode; a separator between the positive electrode and the negative electrode; and the electrolyte in accordance with the aspects and embodiments of the disclosure.

In embodiments, the lithium metal layer may have a thickness of 10 μm to 200 μm.

In embodiments, the positive electrode may include at least one of LiCoO₂, Li(NiₓCo_{y}Mn_{z})O₂, and/or Li(NiₓCo_{y}Al_{z})O₂, and wherein x+y+z=1.

As disclosed herein, the electrolyte for the lithium metal battery according to an embodiment can improve durability performance of a lithium metal battery.

### BRIEF DESCRIPTION OF THE DRAWINGS

FIG. 1 shows the results of evaluating the durability performance of Li/NCM811 coin cells using electrolytes according to Example 1, Comparative Example 1, and Comparative Examples 5 to 8 under high-power conditions (1C).

FIG. 2 shows the results of lithium reversibility evaluation of Cu/NCM811 negative electrode-free coin cells (1/3C) using electrolytes according to Example 1, Comparative Example 1, and Comparative Examples 3 to 7.

FIG. 3 shows the results of evaluating the durability performance of Li/NCM811 coin cells (1/3C) using the electrolytes according to Example 1, Comparative Examples 1 to 4, and Comparative Example 8.

FIG. 4 shows the results of evaluating the durability performance of Li/NCM811 pouch cells (1/3C) using electrolytes according to Example 1 and Comparative Example 1.

FIG. 5 shows the results of evaluating the durability performance of Li/NCM811 coin cells (1/3C) using the electrolytes according to Example 1 and Reference Examples 1 to 3.

FIG. 6A is a scanning electron microscope photograph (top view) of the electrolyte according to Comparative Example 1.

FIG. 6B is a scanning electron microscope image (SEM, top view) of the electrolyte according to Example 1.

FIG. 6C is an SEM-Energy Dispersive X-ray Spectroscopy (EDS) mapping analysis images (top view) of the electrolyte according to Example 1. The white dots on the surface represent calcium.

FIG. 7A is a scanning electron microscope photograph (side-view) of the electrolyte according to Comparative Example 1.

FIGS. 7B to 7D are scanning electron microscope images (side-view) and Energy Dispersive X-ray Spectroscopy (EDS) mapping analysis images (side-view) of the electrolyte according to Example 1, respectively. In FIG. 7D, white dots on the surface represent calcium elements.

FIG. 8A is a scanning electron microscope photograph (left panel, top view) and an EDS mapping analysis photograph (right panel, top view) of the electrolyte according to Reference Example 1. In FIG. 8A, right panel, white dots on the surface represent calcium.

FIG. 8B is a scanning electron microscope photograph (left panel, top view) and an EDS mapping analysis photograph (right panel, top view) of the electrolyte according to Example 1. In FIG. 8B, right panel, white dots on the surface represent calcium.

FIG. 8C is a scanning electron microscope photograph (left panel, top view) and an EDS mapping analysis photograph (right panel, top view) of the electrolyte according to Reference Example 2. In FIG. 8C, right panel, the white dots on the surface represent calcium.

FIG. 8D is a scanning electron microscope photograph (left panel, top view) and an EDS mapping analysis photograph (right panel, top view) of the electrolyte according to Reference Example 3. In FIG. 8D, right panel, the white dots on the surface represent calcium.

FIG. 9A is a scanning electron microscope photograph (middle two panels, cross section-view) and an EDS mapping analysis photograph (far left and far right panels, cross section-view) of the electrolyte according to Reference Example 1. In FIG. 9A, far left and far right panels, the black dots on the surface represent calcium.

FIG. 9B is a scanning electron microscope image (middle two panels, cross section-view) and an EDS mapping analysis image (far left and far right panels, cross section-view) of the electrolyte according to Example 1. In FIG. 9B, far left and far right panels, the white dots on the surface represent calcium.

FIG. 9C is a scanning electron microscope photograph (middle two panels, cross section-view) and an EDS mapping analysis photograph (far left and far right panels, cross section-view) of the electrolyte according to Reference Example 2. In FIG. 9C, far left and far right panels, the white dots on the surface represent calcium.

### DETAILED DESCRIPTION

Unless indicated otherwise, it is to be understood that all the terms used herein comprising technical and scientific terms have the same meaning as those generally understood by those skilled in the art to which the present disclosure pertains. It should also be understood that the terms used throughout the disclosure generally have their common meanings as used in a dictionary and any particular meanings within the context of the related art, unless clearly defined otherwise herein.

In the present application, the terms such as ‘first’ and ‘second’ may be used to describe various components, but these components are not to be interpreted to be limited to these terms. The terms are used only to distinguish one component from another component. For example, the first component may be named the second component and the second component may also be similarly named the first component, without departing from the scope of the present disclosure (i.e., that separate components are identified in some manner).

Terms used in the present specification are used only in order to describe specific exemplary embodiments rather than limiting the present disclosure. Singular forms include plural forms unless the context clearly indicates otherwise. It will be understood that the terms “includes” or “have” or “comprises” used in this specification, specify the presence of stated features, numerals, steps, operations, components, parts mentioned in this specification, or a combination thereof, but do not preclude the presence or addition of one or more other features, numerals, steps, operations, components, parts, or a combination thereof. Those terms will also be understood to encompass transitional terms such as “consisting of” and “consisting essentially of” which can be used to specify the presence of the stated feature(s) and minor amounts of other components or features that do not have any substantial effect on the operability of the embodiments, and/or can be used to specify the presence of the stated feature(s) only, to the exclusion of any additional feature(s).

As used herein, the term “combination(s) thereof” refers to one or more mixtures or combinations of the components recited a list of alternatives and includes at least one selected from the recited list.

The detailed description that follows provides a number of aspects and embodiments that are exemplary and illustrative of the described technology. As those skilled in the art will appreciate, the described aspects and embodiments may be modified in various ways, all without departing from the spirit or scope of the disclosure.

### <Electrolyte for Lithium Metal Battery>

Research and development on electrolytes, including organic electrolytes, that are useful in a lithium metal battery has identified salts or solvents that include a fluorosulfonyl functional group. Salts such as lithium bis(fluorosulfonyl)imide (LiFSI), lithium bis(trifluoromethanesulfonyl)imide (LiTFSI), and the like, have been used in conventional lithium ion or lithium metal batteries, so more recent research and development has focused on an electrolyte composition that includes a carbonate-based solvent and an ether-based solvent with the above-mentioned salts. Some research suggests that a bis(fluorosulfonyl)amide (FSA)-based electrolyte may improve performance of a lithium metal battery, when used with salts having a similar structure, such as LiFSI, LiTFSI, and the like.

However, it has been found that such compositions can form a thick, porous SEI interface (or SEI layer) during the charge and discharge of a battery, which may cause side reactions, and deteriorate the durability and performance of the battery. As these compositions can limit life cycle and have low oxidation stability, there remains a need to develop compositions that can delay salt decomposition and improve oxidation resistance.

As described herein, the disclosure provides an electrolyte composition that can dramatically improve battery durability performance by introducing a functional additive comprising metal ions such as, for example, calcium cations in the composition. In embodiments, the metal ions (cations) are included within a particular amount or concentration range that is sufficient to form a thin SEI interface and induce uniform electrodeposition/desorption of lithium metal. Such embodiments avoid the problems associated with the state of the art (e.g., thick SEI interface formation and associated side reactions).

In accordance with embodiments of the disclosure, an electrolyte comprising the composition described herein (e.g., including salts and solvents having a fluorosulfonyl group and an additive comprising a metal ion) can maximize the electrodeposition-desorption reversibility of lithium and significantly improve durability performance of a lithium metal battery. In particular embodiments, the amount of the additive comprises particular working ranges.

The electrolyte for a lithium metal battery according to an embodiment may include a lithium salt; a non-aqueous organic solvent; and a metal cation additive. Without being limited by mechanism, it may be that the metal cation additive can function to suppress any side reactions between lithium metal and the electrolyte and/or induce dense electrodeposition of the lithium, which can increase reversibility of electrodeposition/desorption reaction of the lithium metal and, simultaneously, suppress growth of dendritic lithium, which improves durability performance of a lithium metal battery comprising such an electrolyte.

In some embodiments, the metal cation additive can comprise metal cations and, in some further embodiments, the cations can comprise calcium cations (i.e., Ca²⁺). While calcium is one of the most abundant and inexpensive minerals in nature, which provides for potential economic savings, calcium ions have not been incorporated as an essential component of a lithium ion battery, or as an electrolyte component in a lithium metal battery.

In some embodiments, the metal cation additive may further comprise trifluoromethanesulfoneimide as an anion in addition to the calcium cation (e.g., the metal cation additive can comprise a calcium cation and a trifluoromethanesulfoneimide anion).

In some further embodiments, the metal cation additive comprises calcium(II) bis(trifluoromethanesulfonimide).

In some embodiments, the metal cation additive may be included in an amount of greater than 0.5 wt % and less than 5 wt %, for example, 1 wt % to 4 wt %, 1 wt % to 3 wt %, or 1 wt % to 2 wt %, based on total weight of the electrolyte. In embodiments wherein the amount of the metal cation additive (e.g., calcium(II) bis(trifluoromethanesulfoneimide) and the like), falls within these ranges the electrolyte can improve battery durability performance. In contrast, when the metal ion additive is included in amounts outside of the above ranges (e.g., less than or equal to 0.5 wt % or greater than or equal to 5 wt %), the thickness of the SEI interface that forms can be too thick, which can lead to non-uniform lithium electrodeposition and poor or rapidly deteriorating durability and performance.

In some embodiments, the non-aqueous organic solvent may include fluorosulfonamide (FSA). FSA is very compatible with a lithium metal negative electrode and is very compatible with lithium salts, such as those comprising a fluorosulfonyl group. Accordingly, when an electrolyte composition according to an embodiment comprises FSA as a solvent, the SEI interface characteristics of lithium metal may be improved, and durability performance may be significantly improved.

In some embodiments, the present disclosure relates to an electrolyte comprising a composite salt that comprises FSA and a fluorosulfonyl group, suitably in amounts sufficient for improving durability performance of a lithium metal battery. In some embodiments, the fluorosulfonyl group-containing composite salt may refer to the metal cation additive described above, and a lithium salt as described hereinbelow.

According to some embodiments, the lithium salt may include a fluorosulfonyl group such as the non-limiting examples of lithium bis(fluorosulfonyl)imide (LiFSI), lithium bis(perfluoroethylsulfonyl)imide (LiBETI), and/or lithium bis(trifluoromethanesulfonyl)imide (LiTFSI). In some further embodiments, the lithium salt may be LiFSI.

In some embodiments, the concentration of the lithium salt included in the electrolyte for a lithium metal battery may be within a range of 2.5 M to 4.5 M, and in some specific embodiments may be from 2.6 M to 4.4 M, 2.7 M to 4.3 M, 2.8 M to 4.2 M, 2.9 M to 4.1 M, or 3.0M to 4.0M.

In embodiments wherein the concentration of the lithium salt is below the above ranges, the conductivity of the electrolyte may decrease, which may result in poor electrolyte performance. Further, in embodiments wherein the concentration of the lithium salt exceeds the above range, the viscosity of the electrolyte may increase, which may result in reduced mobility of lithium ions, and an overvoltage that may occurring from the beginning of the cycle. In addition, outside of the above ranges, the insufficient or excess amount of lithium may lead to undesirable SEI layer formation (i.e., on the surface of the lithium metal as the negative electrode)), where the SEI layer may not be formed at all, or may be too thick, either of which may lower the electrochemical performance of the lithium metal battery.

In some embodiments, the lithium salt and non-aqueous organic solvent may be included in a molar ratio of 1:3 (salt:solvent). In embodiments wherein the cationic metal additive is introduced into a composition in which the lithium salt and the non-aqueous organic solvent are mixed at the molar ratio described above, the improvement in cycle performance and durability characteristics of the lithium metal battery can be maximized.

### <Lithium Metal Battery>

In other aspects and embodiments, the disclosure provides a lithium metal battery including the electrolyte for a lithium metal battery in accordance with the aspects and embodiments described herein.

In some embodiments, the lithium metal battery may include a positive electrode, a lithium metal layer as a negative electrode arranged to face the positive electrode, a separator interposed between the positive electrode and the negative electrode, and the electrolyte in accordance with the disclosure.

In some embodiments, the negative electrode for a lithium metal battery comprises a lithium metal layer, and the lithium metal layer itself may be used as a negative electrode for a battery.

In such embodiments, a battery including the negative electrode may allow lithium ions from the positive electrode to move to the negative electrode to form a lithium metal layer when charged. Charging and discharging of the battery may be proceeded by forming or removing this lithium metal layer.

In some embodiments, the negative electrode may be formed on a negative electrode current collector such as, for example, copper.

In some embodiments, the lithium metal layer may be formed on the negative electrode current collector by action of charging and discharging of the lithium metal battery.

In some embodiments, the lithium metal layer may have a thickness of 10 μm to 200 μm. In some embodiments, the lithium metal layer may be formed to have a thickness of 10 μm to 200 μm.

In embodiments wherein the lithium metal layer satisfies the above thickness, side reactions between the lithium metal layer and the electrolyte may be suppressed, thereby improving the electrochemical performance of the lithium metal battery.

In another embodiment, the positive electrode is disposed opposite the negative electrode.

In some embodiments, the positive electrode may include a positive electrode current collector and a positive electrode active material layer formed on the positive electrode current collector.

In some embodiments, the positive electrode collector may be made of stainless steel, aluminum, nickel, titanium, calcined carbon, or aluminum or stainless steel surface-treated with carbon, nickel, titanium, silver, and the like.

In some embodiments, the thickness of the positive electrode collector may be 3 μm to 500 μm.

The positive electrode active material layer includes a positive electrode active material. In some embodiments, the positive electrode active material may be a compound that is capable of intercalating and deintercalating lithium. In some specific embodiments, the electrode active material may include a lithium metal oxide that comprises at least one of cobalt, manganese, nickel, and/or aluminum. In some specific embodiments, the lithium metal oxide may include at least one of a lithium-manganese-based oxide, a lithium-cobalt-based oxide, a lithium-nickel-based oxide, a lithium-nickel-manganese-based oxide, a lithium-nickel-cobalt-based oxide, a lithium-manganese-cobalt-based oxide, a lithium-nickel-manganese-cobalt-based oxide, a lithium-manganese-cobalt-based oxide, or a lithium-nickel-cobalt-transition metal (M) oxide.

In some embodiments, the positive electrode active material may be a lithium-nickel-manganese-cobalt-based oxide that can improve the capacity characteristics and stability of the battery. In some further embodiments, the lithium-nickel-manganese-cobalt-based oxide comprises Li(NiₓCo_{y}Mn_{z})O₂, wherein x+y+z=1. In yet further embodiments, the lithium-nickel-manganese-cobalt-based oxide can comprise Li(Ni_{0.6}Mn_{0.2}Co_{0.2})O₂, Li(Ni_{0.5}Mn_{0.3}Co_{0.2})O₂, and/or Li(Ni_{0.8}Mn_{0.1}Co_{0.1})O₂.

In some embodiments, the positive electrode active material may include LiCoO₂, Li(NiₓCo_{y}Al_{z})O₂ wherein x+y+z=1, or a combination thereof, in addition to the lithium-nickel-manganese-cobalt-based oxide.

In some embodiments, the positive electrode active material layer may further include a binder and/or a conductive material.

In embodiments, the separator is configured to separate (i.e., physically separate) the negative electrode and the positive electrode, and provides a passage (e.g., flow path) for lithium ions to move (migrate). The separator is not particularly limited and can comprise a separator that is commonly used in rechargeable lithium batteries.

The following examples merely illustrate some embodiment in accordance with the disclosure in more detail. As such, it will be appreciated that the following examples only represent some selected embodiments, and the these Examples are not limiting to the scope of the technology disclosed herein.

### (Example) Preparation of Electrolyte for Lithium Metal Battery

LiFSI salt is added to an FSA solvent at a concentration of 3.4 M and is mixed to form a solution. Calcium hydride (CaH₂) is then added in an amount of greater than or equal to 1% of that of the solution weight and is stirred for 30 minutes to separate liquid and solid phases. After a liquid phase solution was obtained, a metal cation additive was mixed therewith to prepare an electrolyte composition for a rechargeable lithium battery. In this example, the LiFSI salt and the FSA solvent were added in amounts such that the molar ratio of salt:solvent was 1:3 in all the electrolytes.

In Table 1, the electrolyte compositions according to the above example, the reference examples, and the comparative examples are described. In Comparative Example 1, there was no addition of metal cation additive.

TABLE 1

| | LiFSI | FSA | |
|---|---|---|---|
| | concen- | (volume | Metal cation |
| | tration (M) | %) | additive (wt %) |
| Example 1 | 3.4 | 100 | Ca(TFSI)₂ (1.5 wt %) |
| Reference Example 1 | 3.4 | 100 | Ca(TFSI)₂ (0.5 wt %) |
| Reference Example 2 | 3.4 | 100 | Ca(TFSI)₂ (5 wt %) |
| Reference Example 3 | 3.4 | 100 | Ca(TFSI)₂ (15 wt %) |
| Comparative Example 1 | 3.4 | 100 | — |
| Comparative Example 2 | 3.4 | 100 | LiTFSI (1.5 wt %) |
| Comparative Example 3 | 3.4 | 100 | Mg(TFSI)₂ (1.5 wt %) |
| Comparative Example 4 | 3.4 | 100 | La(TFSI)₃ (1.5 wt %) |
| Comparative Example 5 | 3.4 | 100 | Ba(TFSI)₃ (1.5 wt %) |
| Comparative Example 6 | 3.4 | 100 | KTFSI (1.5 wt %) |
| Comparative Example 7 | 3.4 | 100 | Cu(TFSI)₂ (1.5 wt %) |
| Comparative Example 8 | 3.4 | 100 | CsTFSI (1.5 wt %) |

### (Evaluation Example 1: 1 C Evaluation of Composite-Salt Li/NMC According to Salt Type (High-Power Durability Evaluation))

This example incorporates the following elements:

Cell type: 20 to 50 μm Li/W-scope separator (16 pi)/NCM811 positive electrode, 1.5 T spacer, coin type cell (2032)

Electrolyte injection amount: 15 μl

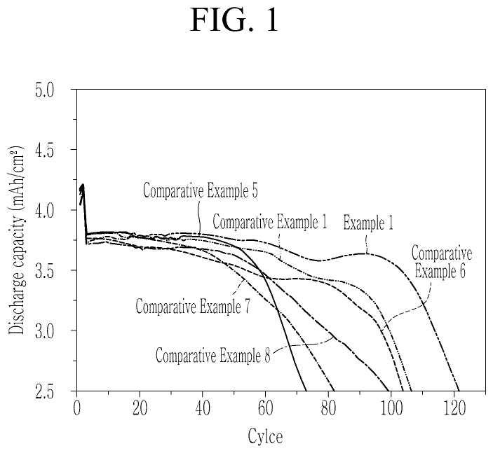

Li/NMC 1 C durability of a composite salt in which another salt was added to conventional LiFSI salt, was evaluated, and the results are shown in FIG. 1 and Table 2.

TABLE 2

| Electrolyte | Capacity Retention (cycle) @ret. 70% |
|---|---|
| Example 1 | 119 |
| Comparative Example 1 | 108 |
| Comparative Example 5 | 73 |
| Comparative Example 6 | 108 |
| Comparative Example 7 | 82 |
| Comparative Example 8 | 97 |

Referring to FIG. 1 and Table 2, the electrolyte of Example 1 exhibited excellent durability performance in the 1 C high power durability testing.

### Evaluation Example 2: 1/3 C Evaluation of Lithium Deposition Reversibility

This example incorporates the following elements:

Cell type: Cu/W-scope separator (16 pi)/NCM811 positive electrode, 1.5T spacer, coin type cell (2032)

Electrolyte injection amount: 15 μl

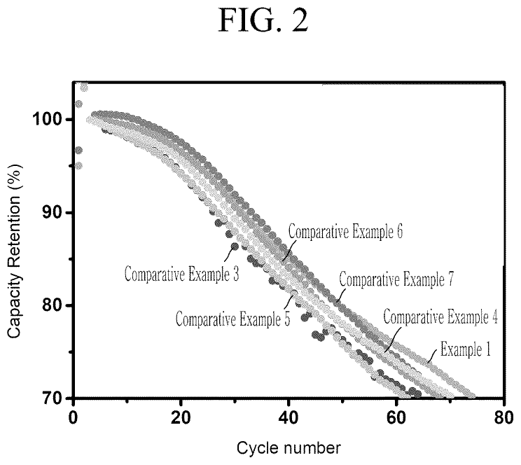

To evaluate the molecular species and structure within the electrolyte, the electrolytes were prepared to have the ratios of lithium salt (LiFSI) and solvent (FSA) described above and then, evaluate lithium reversibility. The results are shown in FIG. 2 and Table 3. Because the lithium reversibility evaluation was performed with a Cu foil having no lithium as a negative electrode and using lithium alone as a positive electrode during the charge/discharge, reversible lithium deposition was quantitatively measured using the decrease in discharge capacity during the charge/discharge.

TABLE 3

| | Capacity Retention | Average C.E. (%) |
|---|---|---|
| Electrolyte | (cycle) @ret. 70% | 11^{th} - cap. ret. 70% |
| Example 1 | 74 | 99.44 |
| Comparative Example 1 | 69 | 99.41 |
| Comparative Example 3 | 64 | 99.43 |
| Comparative Example 4 | 70 | 99.41 |
| Comparative Example 5 | 62 | 99.35 |
| Comparative Example 6 | 68 | 99.40 |
| Comparative Example 7 | 68 | 99.39 |

Referring to FIG. 2 and Table 3, the lithium reversibility evaluation as a function of the electrolyte during charge-discharge in the various composite-salt electrolyte compositions confirmed that Example 1 exhibited the highest reversibility. Without being limited by mechanism, it appears that the presence of calcium cations (Ca²⁺) was able to induce uniform internal deposition of lithium and improve the lithium deposition reversibility.

### Evaluation Example 3: 1/3C Evaluation of Lithium Metal Battery Durability Based on Metal Cation Salt

This example incorporates the following elements:

Cell type: 20 to 50 μm Li/W-scope separator (16 pi)/NCM811 positive electrode, 1.5 T spacer, coin type cell (2032)

Electrolyte injection amount: 15 μl

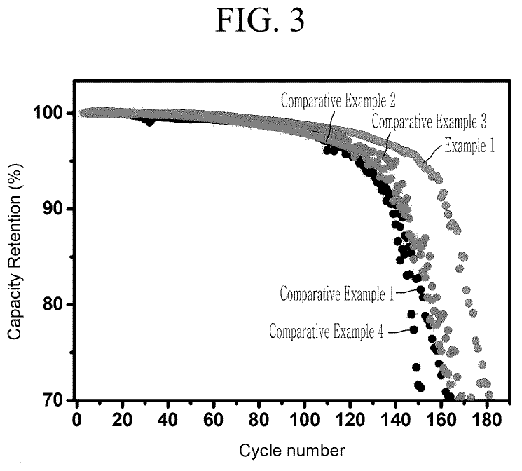

This example evaluates battery (Li/NMC 1/3 C) durability as a function of the composition of a composite salt, in which another salt was added to a conventional LiFSI salt. The results are shown in FIG. 3 and Table 4. Evaluation Example 3 was performed to verify whether the above composite salt forms a more dense SEI interface that can induce uniform lithium deposition, thereby improving durability performance, as compared to SEI interface typically formed with conventional electrolyte compositions.

TABLE 4

| Electrolyte | Capacity Retention (cycle) @ret. 70% |
|---|---|
| Example 1 | 181 |
| Comparative Example 1 | 164 |
| Comparative Example 2 | 164 |
| Comparative Example 3 | 169 |
| Comparative Example 4 | 151 |

Referring to FIG. 3 and Table 4, the electrolyte of Example 1 exhibited the best durability performance in the 1/3 C evaluation.

### Evaluation Example 4: 1/3 C Evaluation of Li/NMC Pouch Cell Durability

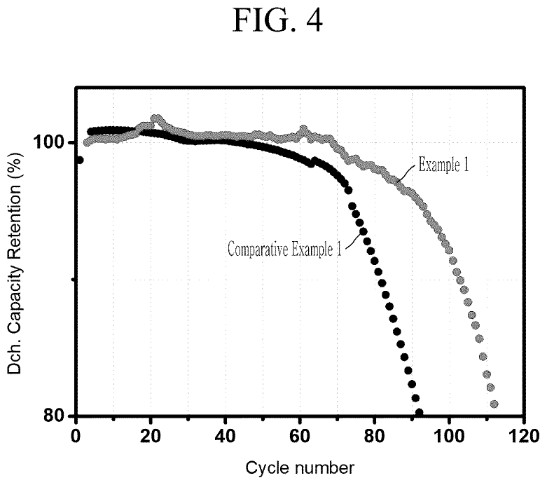

The durability of the composite salt in which another salt was added to conventional LiFSI salt, was evaluated in Li/NMC 1/3 C cells by changing the Li-NMC battery cells from the coin cells to pouch cells (0.2 Ah) for evaluation of commercialization. The durability of a composite salt, was evaluated with the results shown in FIG. 4 and Table 5. This Evaluation Example 4 is performed to determine whether scaled-up pouch cells manufactured at commercialization scale can exhibit improved durability performance, compared to the coin cells.

TABLE 5

| Electrolyte | Cycle-life (cycle) |
|---|---|
| Example 1 | 117 |
| Comparative Example 1 | 100 |

As shown in FIG. 4 and Table 5, when the electrolyte of Example 1 was used, the durability performance of the 1/3 C format was excellent and improved relative to a Comparative Example.

### (Evaluation Example 5: 1/3 C Evaluation of Lithium Metal Battery Durability Based on Amount of Additive (Ca(TFSI)₂)

This example incorporates the following elements:

Cell type: 20 to 50 μm Li/W-scope separator (16 pi)/NCM811 positive electrode, 1.5 T spacer, coin type cell (2032).

Electrolyte injection amount: 15 μl.

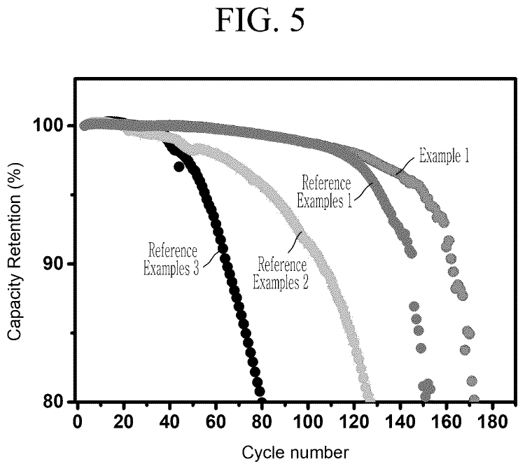

The results of Evaluation Examples 1 to 4 confirmed that Ca(TFSI)₂ was a particularly effective metal cation additive. The evaluations were performed by measuring performance based on the varying amount of the calcium cation additive, with the results shown in FIG. 5 and Table 6. This Evaluation Example 5 also helped to determine whether the density of the SEI interface changed based on the amounts of Ca(TFSI)₂ and whether it can help induce uniform lithium deposition, thereby improving durability performance.

TABLE 6

| Electrolyte | Capacity Retention (cycle) @ret. 80% |
|---|---|
| Example 1 | 172 |
| Reference Example 1 | 153 |
| Reference Example 2 | 126 |
| Reference Example 3 | 79 |

Referring to FIG. 5 and Table 6, when the electrolyte of Example 1 was used, with the amount of Ca(TFSI)₂ additive at 1.5 wt %, the data showed that embodiment to have the best durability performance in the 1/3 C durability evaluation.

### Evaluation Example 6: Electrolyte SEM-EDS Analysis

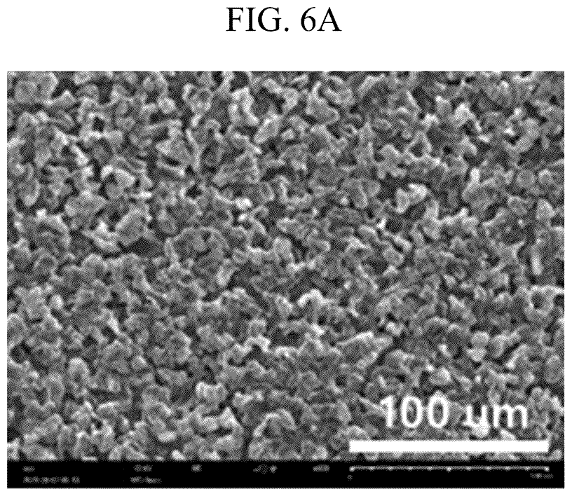

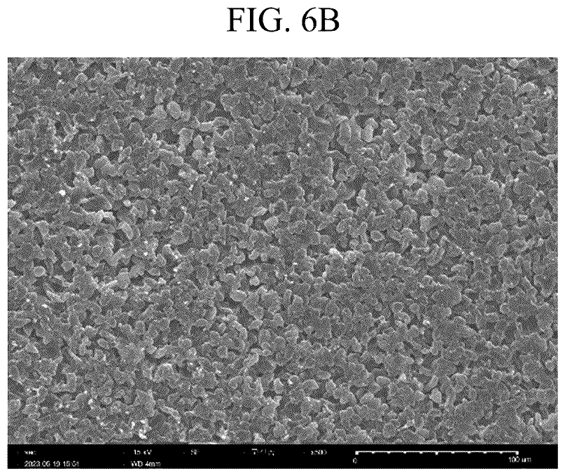

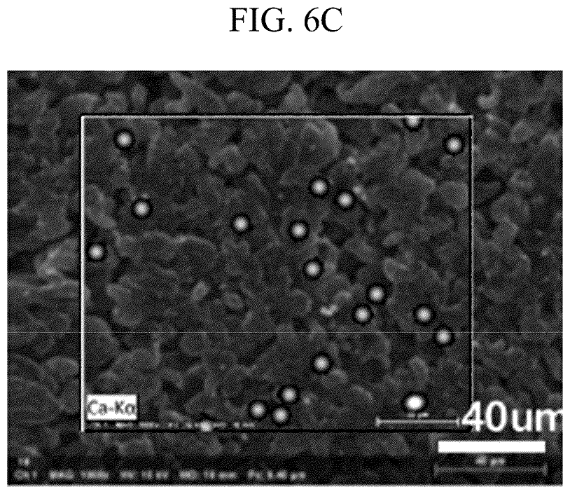

(1) The electrolytes of Example 1 and Comparative Example 1 were examined using SEM images under conditions of 0.1 C for ×2, 4 mAhcm⁻² for 1.33 mAcm⁻²×5 cyc, and Ch to observe their surfaces (top-view), and the microscope images were subjected to SEM-EDS analysis to observe the distribution of individual elements, including calcium, with the results shown in FIGS. 6A to 6C.

FIG. 6A depicts the SEM image of the electrolyte of Comparative Example 1, and FIGS. 6B and 6C depict the SEM images of the electrolyte of Example 1. The images confirmed that the SEM image of Example 1 had a smoother top-view than that of Comparative Example 1, and furthermore, FIG. 6C shows that the Ca atoms were observable on the surface.

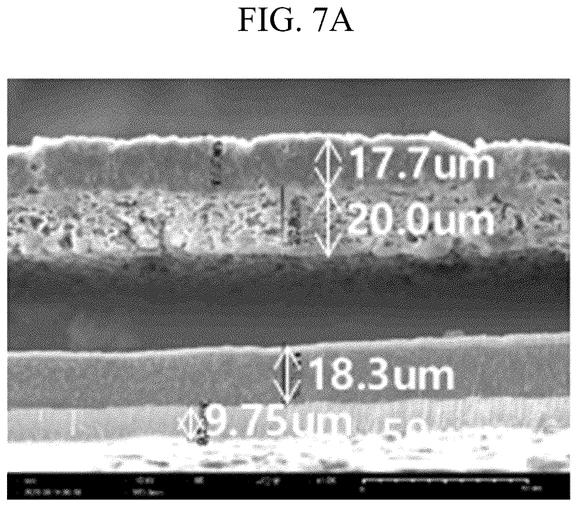

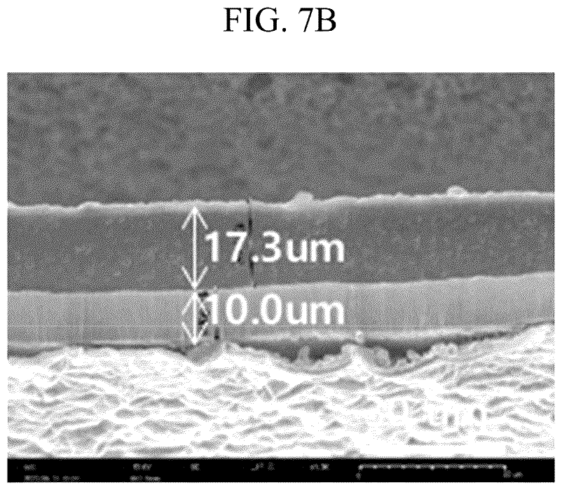

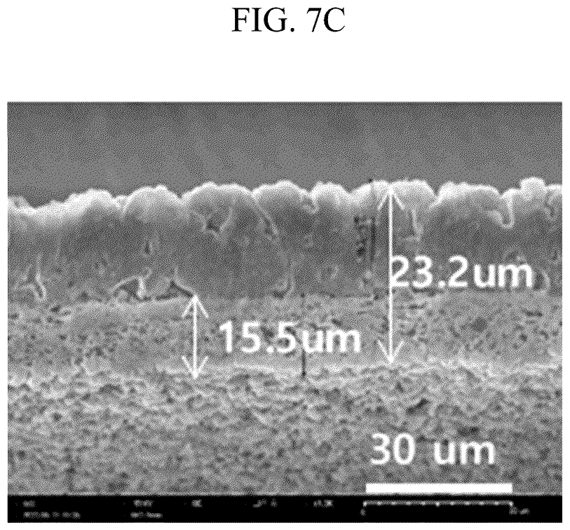

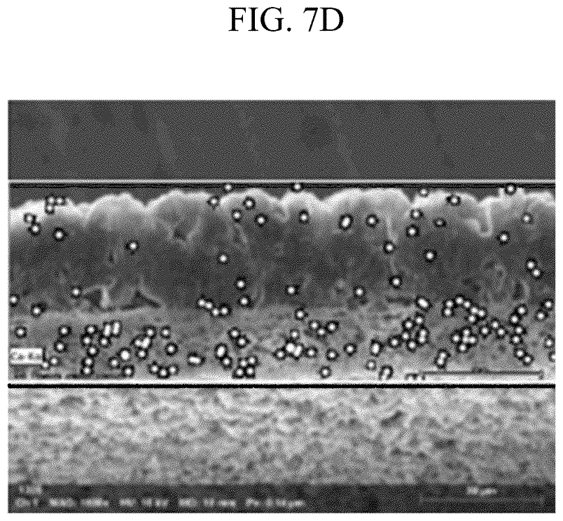

(2) The electrolytes of Example 1 and Comparative Example 1 were examined using SEM images under conditions of 0.1 C for ×2, 4 mAhcm⁻² for 1.33 mAcm⁻²×5 cyc, and Ch to examine their surfaces (side-views), and the microscope images were subjected to SEM-EDS analysis to observe the distribution of individual elements, including calcium, with the results shown in FIGS. 7A to 7D.

FIG. 7A depicts the SEM image of the electrolyte of Comparative Example 1, and FIGS. 7B to 7D depict the SEM images of the electrolyte of Example 1. The images confirmed that the SEM image of Example 1, had an observed thickness of electrodeposited lithium (at 23.2 μm, see e.g., FIG. 7C) that was thinner than the electrodeposited lithium of Comparative Example 1 (at 37.7 μm, see, e.g., FIG. 7A), and that the calcium atoms were distributed on the lithium metal surface. Based on the results, the electrolyte of Example 1 appears to induce a more uniform lithium electrodeposition through formation of the SEI interface relative to Comparative Example 1, and which indicates that uniform lithium electrodeposition would continue to occur as cycles proceed thereafter.

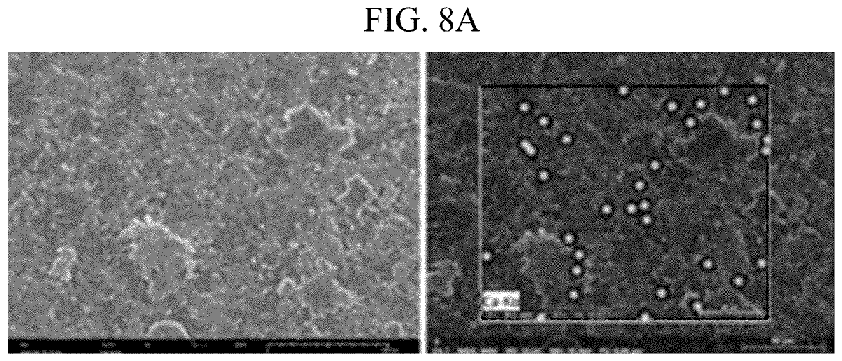

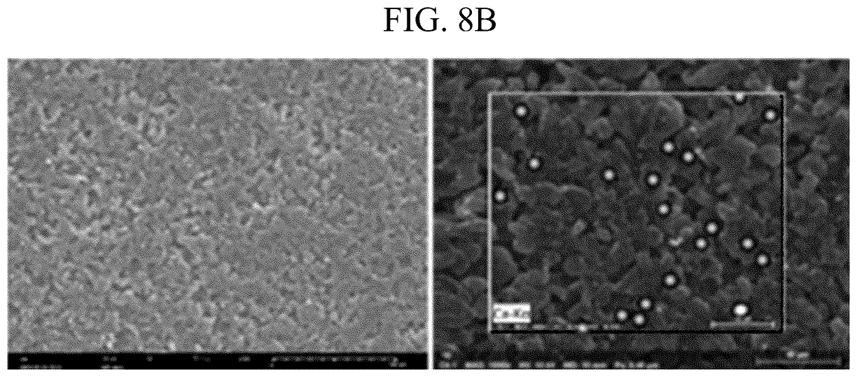

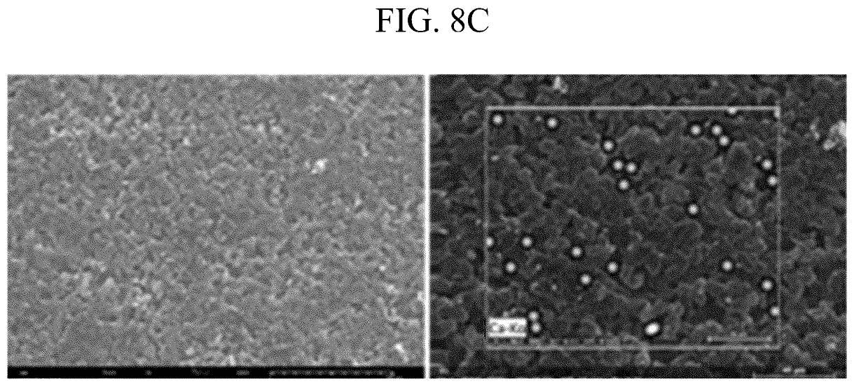

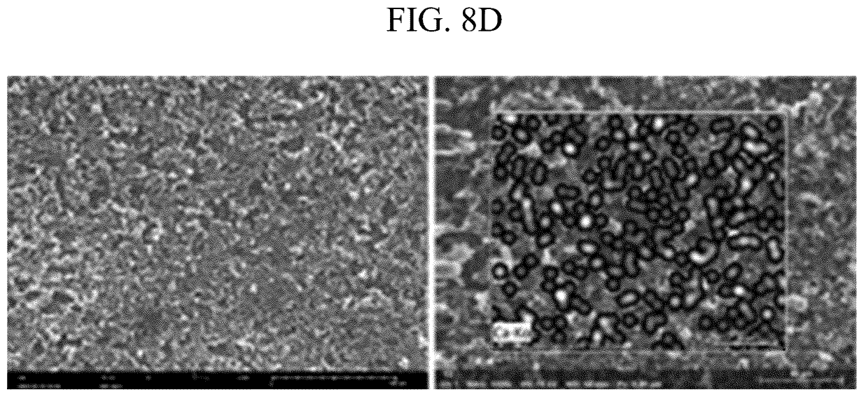

(3) The electrolytes of Example 1 and Reference Examples 1 to 3 were examined using SEM images under conditions of 0.1 C for ×2, 4 mAhcm⁻² for 1.33 mAcm⁻²×5 cyc, and Ch to examine their surfaces (top-view), and the microscope images were subjected to SEM-ED analysis to observe the distribution of individual elements, including calcium, with the results shown in FIGS. 8A to 8D.

FIG. 8A depicts the SEM image of the electrolyte of Example 1, FIG. 8B depicts the SEM image of the electrolyte of Reference Example 1, FIG. 8C depicts the SEM image of the electrolyte of Reference Example 2, and FIG. 8D depicts the SEM image of the electrolyte of Reference Example 3. The results confirm that the SEM image of Example 1 exhibited a smoother surface (top-view) compared to Reference Examples 1 to 3 and furthermore, that Ca was observed to have a large and uniform particle size distribution on the surface. The large and uniform particle size distribution of the Ca atoms confirmed that dead Li (unusable lithium) was minimized during the stripping. Further, because the relatively small surface area was configured to evenly distribute a current to lower current density, the results indicate that when lithium is deposited in subsequent cycles, the structure will induce a dense and uniform electrodeposition of lithium, thereby reducing any side reaction between lithium and electrolyte.

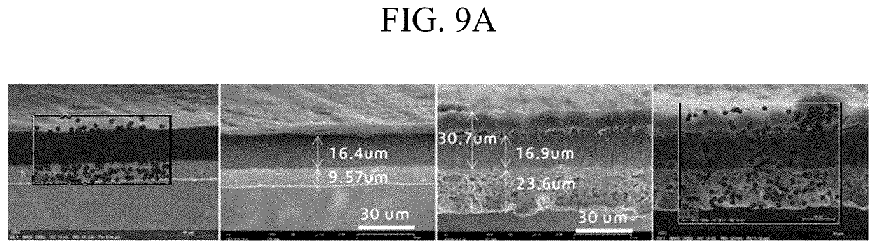

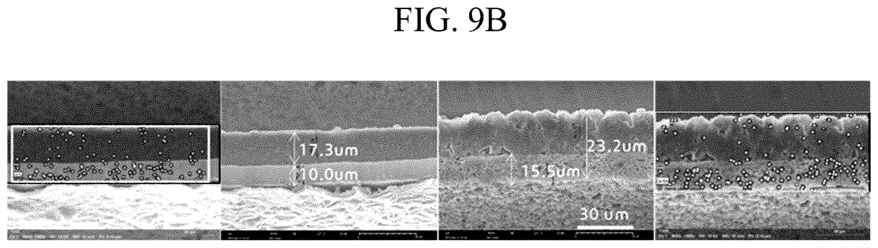

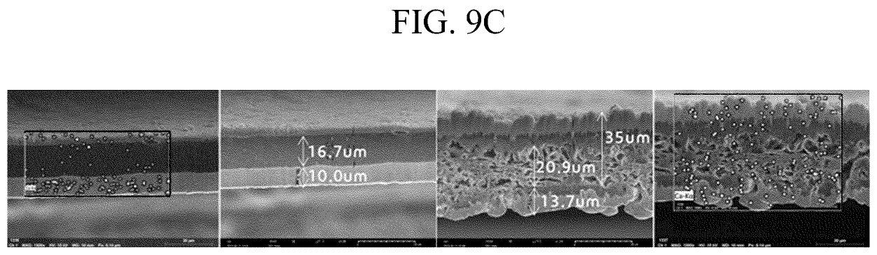

(4) The electrolytes of Example 1 and Reference Examples 1 and 2 were examined using SEM images under conditions of 0.1 C for ×2, 4 mAhcm⁻² for 1.33 mAcm⁻²×5 cyc, and Ch to examine their surfaces (cross section-view), and the SEM images were subjected to SEM-EDS analysis to observe the distribution of individual elements, including calcium, with the results shown in FIGS. 9A to 9C.

FIG. 9A depicts the SEM image of the electrolyte of Reference Example 1, FIG. 9B depicts the SEM image of the electrolyte of Example 1, and FIG. 9C depicts the SEM image of the electrolyte of Reference Example 2. The data confirmed that the SEM image of Example 1 had the smallest thickness of the electrodeposition layer, compared to those of Reference Examples 1 and 2, and accordingly, the results indicate that the electrolyte of Example 1 induced the uniform lithium electrodeposition through formation of an SEI interface, and will result in uniform lithium electrodeposition as cycles proceed thereafter.

Although several embodiments according to the disclosure have been described in detail above, the disclosure is not limited thereto, and various modifications may be made that fall within the scope of the disclosure and appended claims.

What is claimed is:

1. An electrolyte for a lithium metal battery, comprising
a lithium salt;
a non-aqueous organic solvent; and
a metal cation additive;
wherein the metal cation additive comprises calcium and trifluoromethanesulfoneimide.

2. The electrolyte of claim 1, wherein the metal cation additive comprises calcium(II) bis(trifluoromethanesulfonimide).

3. The electrolyte of claim 1, wherein the metal cation additive comprises greater than 0.5 wt % and less than 5 wt % based on total weight of the electrolyte.

4. The electrolyte of claim 1, wherein the non-aqueous organic solvent comprises fluorosulfonamide (FSA).

5. The electrolyte of claim 1, wherein the lithium salt comprises at least one of lithium bis(fluorosulfonyl)imide (LiFSI) and/or lithium bis(trifluoromethanesulfonyl)imide (LiTFSI).

6. The electrolyte of claim 1, wherein the lithium salt comprises a concentration of 2.5 M to 4.5 M.

7. The electrolyte of claim 1, comprising a molar ratio of the lithium salt to the non-aqueous organic solvent of 1:3.

8. A rechargeable lithium metal battery, comprising
a positive electrode;
a lithium metal layer as a negative electrode facing the positive electrode;
a separator between the positive electrode and the negative electrode; and
the electrolyte of claim 1.

9. The rechargeable lithium metal battery of claim 8, wherein the lithium metal layer has a thickness of 10 μm to 200 μm.

10. The rechargeable lithium metal battery of claim 8, wherein the positive electrode comprises at least one of LiCoO₂, Li(NiₓCo_{y}Mn_{z})O₂, and/or Li(NiₓCo_{y}Al_{z})O₂, wherein x+y+z=1.
